(19) United States
(12) Patent Application Publication
(10) Pub. No.: US 2025/0339966 A1
(43) Pub. Date: Nov. 6, 2025

(54) ROBOT CONTROL DEVICE

(71) Applicant: FANUC CORPORATION, Yamanashi (JP)

(72) Inventors: Taketo ITAGAKI, Yamanashi (JP); Gou INABA, Yamanashi (JP)

(21) Appl. No.: 18/869,282

(22) PCT Filed: Jun. 28, 2022
(86) PCT No.: PCT/JP2022/025797

§ 371 Date: Nov. 26, 2024

(51) Int. Cl. B25J 9/16

(52) U.S. Cl. CPC B25J 9/1674

(57) ABSTRACT

Provided is a robot control device that controls a robot. The robot control device includes: a standard function unit that controls activation of standard functions of the robot and has a function of monitoring the robot; a safety function unit that controls a safety function for managing the safety of the robot; a setting unit for setting setting information related to setting items used in common in the control of the safety function by the safety function unit and in the monitoring of the robot by the standard function unit; and a switching unit that switches between the activation of the safety function based on the setting information by the safety function unit and the monitoring of the robot based on the setting information by the standard function unit.

### FIELD

The present invention relates to a robot controller.

### BACKGROUND

For safety of a user and protection of devices, an industrial robot system is preferably provided with a safety function in addition to a standard function for robot control. For example, PTL 1 describes as follows: “A control system for controlling a device, the control system including: a standard function unit performing control of operation of the device; a safety function unit performing control for managing safety of the device; a standard function setting unit performing setting of a setting item related to control by the standard function unit; and a safety function setting unit performing setting of a setting item related to control by the safety function unit, wherein when a content of a first setting item is set in one of the standard function setting unit and the safety function setting unit, a second setting item related to the first setting item is automatically set to a predetermined content corresponding to the content of the first setting item in the other of the standard function setting unit and the safety function unit.” (Claim 1).

PTL 2 relates to a robot controller and describes as follows: “In the invention according to claim 2, a servomotor of a robot performs driving of the robot under control of a servo control unit, and a position detection unit detects an operating position of the robot (such as the position, the angle, a positional variation, or an angular variation of each component of the robot) that varies in accordance with the driving by the servomotor. Then, each computation unit individually determines whether the detected operating position is in a preset allowable operating position, and the servomotor is stopped even when only one of the computation units determines that the operating position is out of the allowable operating position.” (Paragraph 0012).

PTL 3 relates to a manipulator motion limiting device and describes as follows: “In order to achieve an intended objective, the device is configured to define, by a mathematical function, area L data for determining, with an interference determination unit 11, existence of interference in a motion limiting area L as an area contained in a polyhedron, and to determine existence of interference of a manipulator 12 based on the area L data.” (Abstract). PTL 4 describes as follows: “A device is configured to control release/lock of a brake in such a way that the joint moving speed of a robot arm when the brake is released is kept within a certain value even when the shape, the posture, and the load condition of the arm changes, by detecting the joint movement position of the robot arm by a position detector, computing the joint moving speed from a variation in the joint movement position and an elapsed time, and comparing the computed speed with an allowable moving speed.” (ABSTRACT).

### CITATION LIST

### Patent Literature

[PTL 1] Japanese Unexamined Patent Publication (Kokai) No. 2018-136715 A
[PTL 2] Japanese Unexamined Patent Publication (Kokai) No. 2007-136617 A
[PTL 3] Japanese Unexamined Patent Publication (Kokai) No. H07-108487 A
[PTL 4] International Application Publication No. WO 2003/086718 A1

### SUMMARY

### Technical Problem

While the safety function as described above provides a high level of safety in a work environment in which an operator may enter a workspace of a robot, the safety function has an aspect that a considerable amount of burden is imposed on an operator in the operation of the safety function due to, for example, existence of an authentication process required for changing setting parameters of the safety function. On the other hand, a robot controller may have a function of monitoring an operating state of a robot as one of standard functions for regular robot control. However, the safety function and the function of monitoring the operating state of the robot based on the standard function are generally provided as separate functions executed independently of each other. A robot controller enabling a user to smoothly switch between the safety function and the function of monitoring an operating state of a robot based on the standard function, is desired.

### Solution to Problem

An aspect of the present disclosure is a robot controller for controlling a robot, the robot controller including: a standard function unit configured to control operation of a standard function as the robot and have a function of monitoring the robot; a safety function unit configured to control a safety function for managing safety of the robot; a setting unit configured to set setting information related to a setting item used in common in control of the safety function by the safety function unit and monitoring of the robot by the standard function unit; and a switching unit configured to switch between operation of the safety function performed by the safety function unit based on the setting information and monitoring of the robot performed by the standard function unit based on the setting information.

### Advantageous Effects of Invention

The aforementioned configuration enables a user to switch between a safety function and a robot monitoring function based on a standard function in a smooth manner.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating an apparatus configuration of a robot system according to an embodiment.

FIG. 2 is a diagram illustrating a motion zone checking function by a robot controller.

FIG. 3 is a diagram for illustrating an example of an interference checking function by the robot controller.

FIG. 4 is a diagram for illustrating another example of the interference checking function by the robot controller.

FIG. 5 is a diagram illustrating hardware configuration examples of the robot controller and an external input device.

FIG. 6 is a conceptual diagram illustrating configurations of and coordination between a safety function and a standard function.

FIG. 7 is a functional block diagram of the robot controller.

FIG. 8 is a diagram illustrating an example of a UI screen for parameter setting related to a position check.

FIG. 9 is a diagram illustrating an example of a UI screen for parameter setting related to a speed check.

FIG. 10 is a diagram for illustrating a flow of operation when the safety function is switched to the standard function on a UI screen.

FIG. 11 is a diagram for illustrating a flow of operation when the standard function is switched to the safety function on a UI screen.

FIG. 12A is a diagram for illustrating the operation when a setting parameter is changed on a UI screen on which the standard function is selected.

FIG. 12B is a diagram schematically illustrating a state of an actual motion check when the setting change in FIG. 12A is performed.

### DESCRIPTION OF EMBODIMENTS

Next, an example of the present disclosure will be described with reference to drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

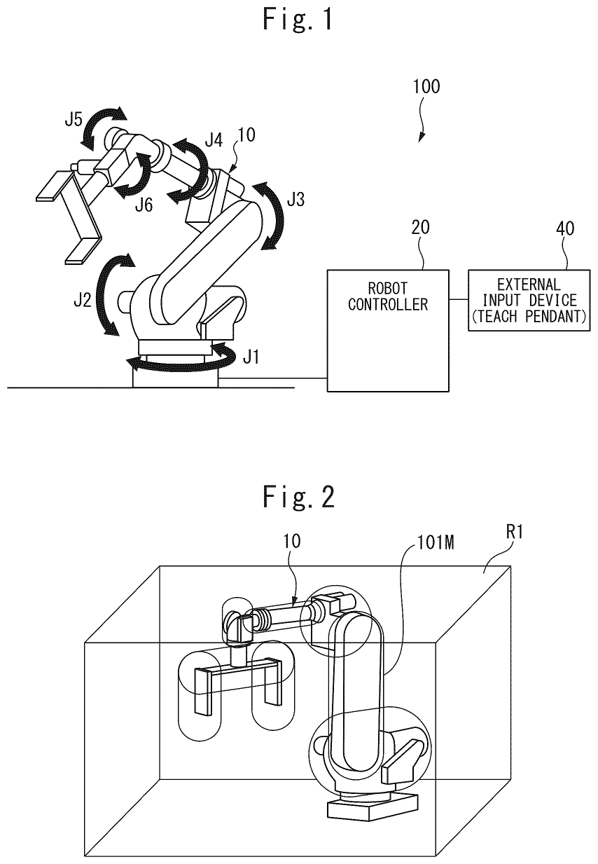

FIG. 1 is a diagram illustrating an apparatus configuration of a robot system 100 according to an embodiment. As illustrated in FIG. 1, the robot system 100 includes a robot 10, a robot controller 20 controlling the robot 10, and an external input device 40 connected to the robot controller 20. For example, the external input device 40 is a teach pendant. An information processing device such as a tablet device, a smartphone, or a personal computer (PC) may be used as the external input device 40. It is assumed as an example that the robot 10 is a six-axis articulated robot. Various types of robots such as a parallel link robot and a dual-arm robot may be used as the robot 10 depending on a work target. Joint axes of the robot 10 are referred to as a J1 axis, a J2 axis, a J3 axis, a J4 axis, a J5 axis, and a J6 axis in this order from the base side. The J1 axis to the J6 axis correspond to rotation axes of actuators provided for the respective axes. FIG. 1 indicates directions of rotation of the axes by arrows J1 to J6.

The robot 10 can perform desired work with an end effector attached to the wrist. The end effector is an external device exchangeable according to the purpose and is, for example, a hand, a welding gun, or a tool. FIG. 1 illustrates an example of a hand as an end effector being used.

A function of the robot system 100 for human safety and protection of devices will be described. The robot controller 20 is provided with a safety function (including a function of stopping the robot when an abnormality in the position or the speed of the robot is detected) for managing the safety in the operation of the robot 10 in addition to a standard function related to control of the robot 10 and peripheral devices. For example, the safety function is configured to satisfy requirements of the international safety standards ISO13849-1 and IEC61508 and be executed in a high-reliability operating environment. For example, for the safety function, a configuration in which the safety function is executed under control of a dedicated processor separately provided from a processor handling the standard function or a configuration in which the position and the speed of a motor for each axis is doubly monitored by a dual processor so that when an abnormality is detected, motive power of servo control can be cut off from each of independent systems, is used. Generally, the safety function has an aspect that a considerable burden is imposed on an operator in the operation of the safety function due to, for example, an authentication process and a system reboot required when applying changed setting parameters of the safety function.

While the safety function provides a high level of safety, for example, in a work environment in which an operator may enter a workspace of a robot, the safety function has an aspect that a considerable amount of time is required for operation of the safety function due to, for example, existence of an authentication process as described above. From such a standpoint, the robot controller 20 is provided with a function of monitoring the position and the speed of a motor for each axis so as to detect an abnormality in the operation of the robot, as the standard function executable by a single processor handling regular robot control. This function does not need to satisfy requirements related to an operating environment and a protection level of a setting parameter as is the case with the safety function described above and therefore has an aspect that a burden imposed on operation of the standard function is relatively low.

A motion zone limiting function of the robot 10 performed in the safety function or the standard function will be described with reference to FIG. 2. FIG. 2 illustrates an example of setting a motion zone R1 around the robot 10 within which the robot 10 is allowed to move. In the case where the motion zone R1 is set, the robot 10 is stopped when the robot 10 performs a motion of departing from the motion zone R1. When such an interference check is performed, cylindrical or spherical models (a robot model 101M) may be set around the robot 10 in such a way as to cover the arm, the joints, and a tool part, and the robot 10 may be stopped when the robot model 101M performs a motion of departing from the motion zone R1.

A limiting zone where the robot 10 is prohibited from entering may be set. In this case, when the robot 10 (or the robot model 101M) performs a motion of entering the limiting zone, the robot 10 is stopped.

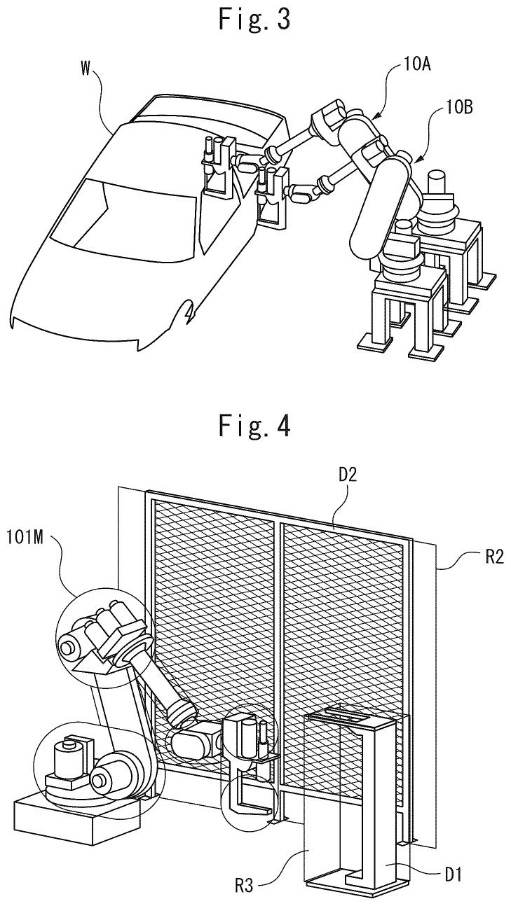

An interference checking function performed in the safety function or the standard function will be described with reference to FIG. 3 and FIG. 4. FIG. 3 illustrates a situation in which work is executed on a workpiece W by a plurality of robots 10A and 10B. In a situation like FIG. 3, for example, a controller of the robot 10A acquires position information of the robot 10B and stops the robot 10A when the robot 10A performs a motion of interfering with the robot 10B.

FIG. 4 illustrates an interference check between the robot 10 and a peripheral device. In FIG. 4, a model R3 representing a peripheral device D1 and a model R2 representing a peripheral device D2 are set. By performing an interference check between the robot model 101M and the models R2 and R3 of the peripheral devices, occurrence of interference between the robot and the peripheral device due to a misoperation or the like during the teaching of the robot can be prevented.

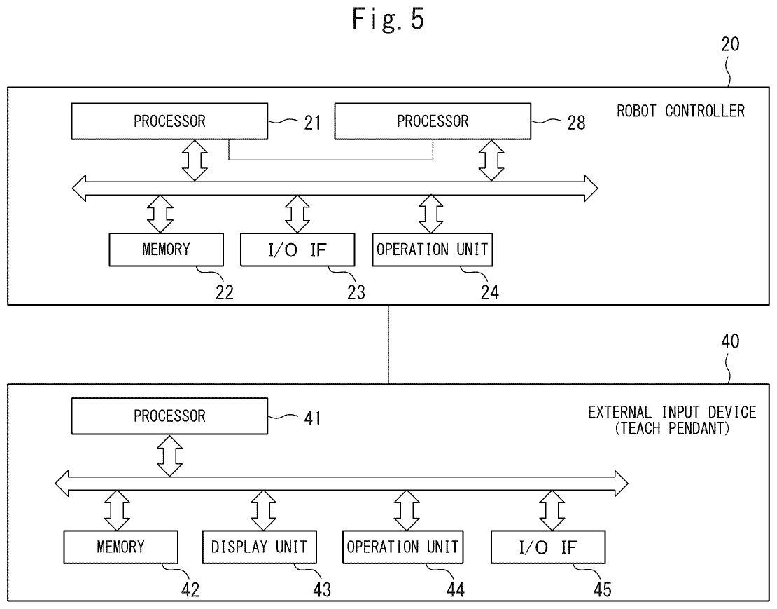

FIG. 5 illustrates hardware configuration examples of the robot controller 20 and the external input device 40. The robot controller 20 may have a configuration as a common computer including a memory 22 (such as a ROM, a RAM, or a nonvolatile memory), various input-output interfaces 23, an operation unit 24 including various operation switches, etc. that are connected to a processor 21 through a bus. The input-output interfaces 23 include a network interface, a serial interface, a sensor signal interface, and other external device interfaces. When the robot controller 20 is configured as a dual CPU system, a processor 28 that can exchange information with the processor 21 is provided. Similarly to the processor 21, the processor 28 may be connected to the memory 22 (such as a ROM, a RAM, or a nonvolatile memory), the various input-output interfaces 23, the operation unit 24 including various operation switches, etc. through the bus.

The external input device 40 may have a configuration as a common computer including a memory 42 (such as a ROM, a RAM, or a nonvolatile memory), a display unit 43, an operation unit 44 including an input device such as a keyboard (or a software keyboard), various input-output interfaces 45, etc. that are connected to a processor 41 through a bus. The input-output interfaces 45 include a network interface, a serial interface, and other external device interfaces.

The robot controller 20 according to the present embodiment is configured to be able to switch between the safety function and the standard function so as to allow a user to select the safety function or the standard function as needed. In this case, when viewed from a user, the setting parameters are shared between the safety function and the standard function.

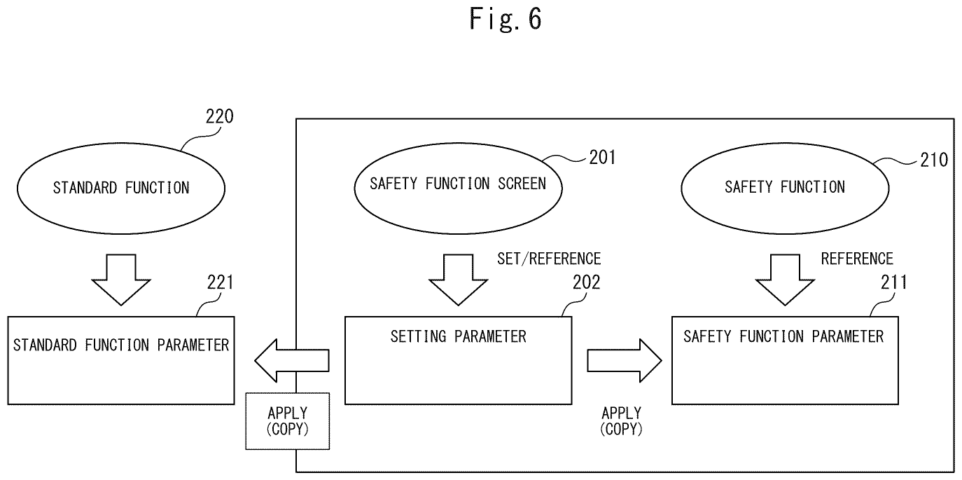

FIG. 6 is a conceptual diagram illustrating configurations of and coordination between the safety function and the standard function. A part enclosed by a rectangular frame in the diagram represents the safety function. A part on the left side of the rectangular frame in the diagram represents the standard function. A setting parameter 202 can be set on a safety function screen 201 provided in the safety function. A safety function parameter 211 is protected in such a way as not to be directly edited. Subjecting the setting parameter 202 set through the safety function screen 201 to an applying process enables the setting parameter 202 to be used as the safety function parameter 211 by the safety function 210. The applying process includes an authentication process such as password input.

The setting parameter 202 is also applied as a standard function parameter 221 for the standard function 220. In this process, the authentication process may not be included.

According to the present embodiment, a checking function based on the safety function and the standard function includes the following.
(Function 1) Abnormal position detection function: A function of monitoring the position of a robot and checking whether the robot (or a robot model set to the robot) has departed from a motion zone or whether the robot (or the robot model set to the robot) has entered a limiting zone. As used herein, a “position of a robot” may include any position on the robot from the base of the robot to the arm tip and a tool. A motion of departing from the motion zone by the tool (a tool model) or the arm (a geometric model of the arm) of the robot may also be detected as an abnormality. The abnormal position detection function may include a function of checking whether each axis position of the robot is out of a set motion range (angle range).
(Function 2) Abnormal posture detection function: For example, a function of checking for an abnormality concerning the posture of a robot by comparing the posture of a flange surface of an arm tip of a robot or a tool (the rotation angle positions around X-, Y-, and Z-axes in a standard coordinate system) with a standard posture (W, P, R).
(Function 3) Model interference detection function: A function of checking whether set models interfere with each other.
(Function 4) Abnormal speed detection function: A function of checking whether a predetermined control part (such as a tool center point (TCP)) of a robot exceeds a set speed limit. The abnormal speed detection function may include a function of checking whether the speed of each axis exceeds a set speed limit.

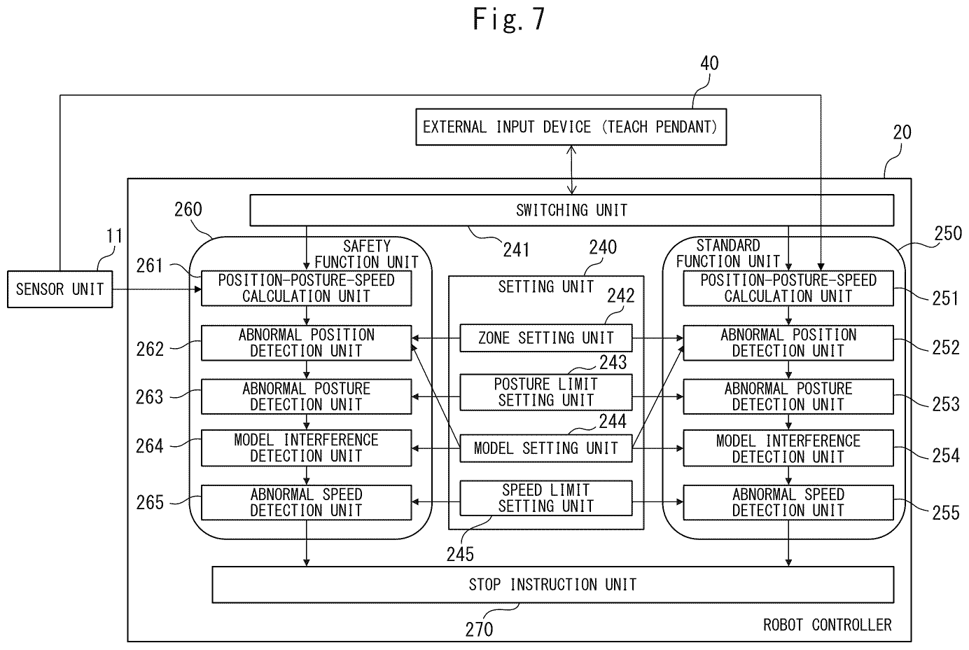

FIG. 7 is a functional block diagram of the robot controller 20. As illustrated in FIG. 7, the robot controller 20 includes a switching unit 241 providing a function of switching between the safety function and the standard function.

The robot controller 20 includes a setting unit 240 for setting setting information including a setting item used in common in the safety function and monitoring of the operation of the robot 10 by the standard function. The setting unit 240 includes a zone setting unit 242, a posture limit setting unit 243, a model setting unit 244, and a speed limit setting unit 245.

The zone setting unit 242 provides a function of setting the position and the size of a motion zone or a limiting zone.

The posture limit setting unit 243 provides a function for setting a standard posture (W, P, R) of the flange surface or the tool, and an upper limit (deg) of a change in the posture relative to the standard posture.

The model setting unit 244 provides a function of setting a model covering the robot, a robot tool, or a peripheral device. In a zone check (position check) and a model interference check, calculations for a violation check are performed by using the models.

The speed limit setting unit 245 provides a function of setting speed limits of a predetermined control part (such as a TCP) of the robot and each axis of the robot.

The robot controller 20 includes a safety function unit 260 handling the safety function. The safety function unit 260 includes a position-posture-speed calculation unit 261, an abnormal position detection unit 262, an abnormal posture detection unit 263, a model interference detection unit 264, and an abnormal speed detection unit 265. The robot controller 20 further includes a stop instruction unit 270.

The position-posture-speed calculation unit 261 can determine the position of the robot 10, the position of each axis of the robot 10, the speed of the robot 10, and the speed of each axis of the robot 10 by kinematical calculations, based on a signal from a sensor unit 11 (such as an encoder) mounted on each joint axis of the robot 10. The position-posture-speed calculation unit 261 can further determine the posture of the flange surface or the tool of the robot 10, based on the output of the sensor unit 11 at each axis.

Based on the position of the robot 10 acquired by the position-posture-speed calculation unit 261, the abnormal position detection unit 262 checks whether the position of the robot 10 has departed from the motion zone or whether the position has entered the limiting zone. When an abnormality is detected, the abnormal position detection unit 262 notifies the stop instruction unit 270 of the abnormality.

The abnormal posture detection unit 263 checks whether a change in the posture of the robot 10 relative to the standard posture (W, P, R), wherein the posture is acquired by the position-posture-speed calculation unit 261, exceeds the upper limit. When an abnormality is detected, the abnormal posture detection unit 263 notifies the stop instruction unit 270 of the abnormality.

The model interference detection unit 264 checks whether interference has occurred between set models, based on the positions of the models calculated by the position-posture-speed calculation unit 261. When an abnormality is detected, the model interference detection unit 264 notifies the stop instruction unit 270 of the abnormality.

The abnormal speed detection unit 265 checks whether the speed of the robot 10 or the speed of each axis of the robot 10 acquired by the position-posture-speed calculation unit 261 exceeds the set speed limit. When an abnormality is detected, the abnormal speed detection unit 265 notifies the stop instruction unit 270 of the abnormality.

When notification of an abnormality is made by the abnormal position detection unit 262, the abnormal posture detection unit 263, the model interference detection unit 264, or the abnormal speed detection unit 265, the stop instruction unit 270 stops the robot 10.

The safety function unit 260 may further have a function as a diagnosis unit performing a diagnosis on whether each abnormality detection unit is operating normally in a state where the safety function is in operation. For example, the diagnosis function may be implemented such that monitoring of status of a program and hardware and monitoring of correctness of parameters are periodically executed.

The robot controller 20 further includes a standard function unit 250 handling monitoring of the operation of the robot 10 in the standard function. The standard function unit 250 includes a position-posture-speed calculation unit 251, an abnormal position detection unit 252, an abnormal posture detection unit 253, a model interference detection unit 254, and an abnormal speed detection unit 255.

The position-posture-speed calculation unit 251 can determine the position of the robot 10, the position of each axis of the robot 10, the speed of the robot 10, and the speed of each axis of the robot 10 by kinematical calculations, based on a signal from the sensor unit 11 (such as an encoder) mounted on each joint axis of the robot 10. The position-posture-speed calculation unit can further determine the posture of the flange surface or the tool of the robot 10, based on the output of the sensor unit 11 at each axis.

Based on the position of the robot 10 acquired by the position-posture-speed calculation unit 251, the abnormal position detection unit 252 checks whether the position of the robot 10 has departed from the motion zone or whether the position has entered the limiting zone. When an abnormality is detected, the abnormal position detection unit 252 notifies the stop instruction unit 270 of the abnormality.

The abnormal posture detection unit 253 checks whether a change in the posture of the robot 10 relative to the standard posture (W, P, R), wherein the posture is acquired by the position-posture-speed calculation unit 251, exceeds the upper limit. When an abnormality is detected, the abnormal posture detection unit 253 notifies the stop instruction unit 270 of the abnormality.

The model interference detection unit 254 checks whether interference has occurred between set models, based on the positions of the models calculated by the position-posture-speed calculation unit 251. The interference check by the model interference detection unit 254 includes an interference check between the robot model and the peripheral device model, interference between a geometric model of the tool and a geometric model of the arm on the robot, etc. When an abnormality is detected, the model interference detection unit 254 notifies the stop instruction unit 270 of the abnormality.

The abnormal speed detection unit 255 checks whether the speed of the robot 10 or the speed of each axis of the robot 10 acquired by the position-posture-speed calculation unit 251 exceeds the set speed limit. When an abnormality is detected, the abnormal speed detection unit 255 notifies the stop instruction unit 270 of the abnormality.

When notification of an abnormality is made by the abnormal position detection unit 252, the abnormal posture detection unit 253, the model interference detection unit 254, or the abnormal speed detection unit 255, the stop instruction unit 270 stops the robot 10.

The monitoring by the functional block related to the safety function (the position-posture-speed calculation unit 261, the abnormal position detection unit 262, the abnormal posture detection unit 263, the model interference detection unit 264, and the abnormal speed detection unit 265) may be doubly executed by the two processors (the processors 21 and 28) included in the robot controller 20 so that the monitoring function with a high level of reliability and a high level of throughput can be achieved. The motive power of the motor of the robot may be reliably cut off through two independent paths when an abnormality is detected in the safety function. Further, in the safety function, the two processors may operate to mutually check processing contents and data used in the processing so as to maintain the reliability in the safety function. Further, in the safety function, in order to avoid accumulation of latent failures, self-diagnosis of hardware and software related to the safety function may be periodically performed.

On the other hand, the functional blocks related to the function for monitoring in the standard function (the position-posture-speed calculation unit 251, the abnormal position detection unit 252, the abnormal posture detection unit 253, the model interference detection unit 254, and the abnormal speed detection unit 255) may be implemented as functions to be executed by a single processor (such as the processor 21 responsible for regular operation control). In this case, double monitoring by two processors, mutual checking by two processors, and self-diagnosis as is the case in the safety function may not be performed.

Next, details of parameter setting by the zone setting unit 242, the posture limit setting unit 243, the model setting unit 244, and the speed limit setting unit 245 will be described. The zone setting unit 242, the posture limit setting unit 243, the model setting unit 244, and the speed limit setting unit 245 may be configured to accept the parameter setting through a user interface (UI) screen. For example, the UI screen may be displayed on a display screen of the display unit 43 of the external input device 40, and an input to the UI screen may be accepted through the operation unit 44.

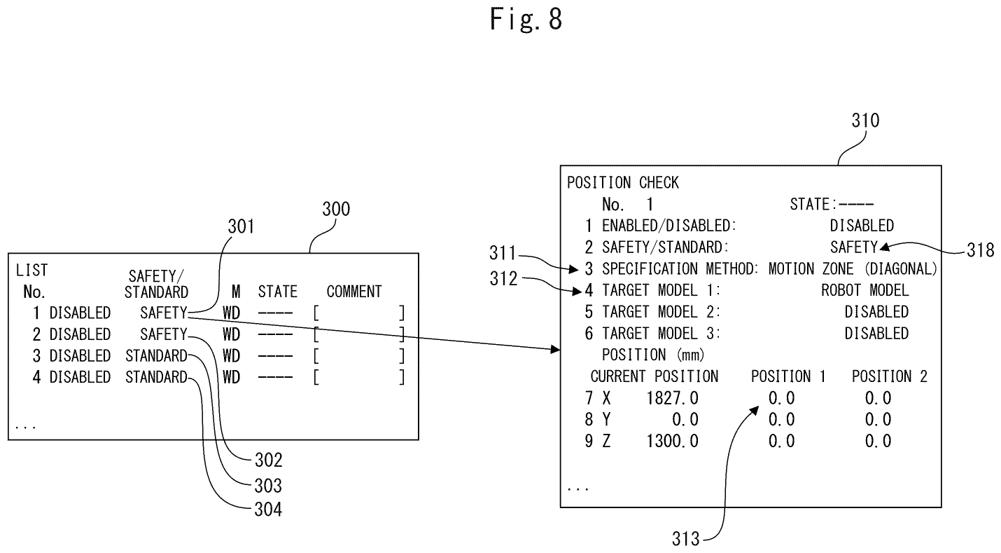

Setting contents on a UI screen 310 illustrated in FIG. 8 are examples of setting contents used when the position check of the robot is performed. The UI screen 310 includes
a specified field 311 for setting a monitoring method,
a specified field 312 for specifying a model used in the position check, and
a specified field 313 for specifying the position and the size of the motion zone or the limiting zone as three-dimensional coordinates.
   The setting contents in the specified field 311 for setting a monitoring method, the specified field 312 for specifying a model, and the specified field 313 for the position and the size of the motion zone or the limiting zone may be used for checks in the abnormal position detection units 252 and 262. The specified field 312 for specifying a model may be used for interference checks in the model interference detection units 254 and 264.

As the monitoring method, the motion zone or the limiting zone for the position check, the posture check or the model interference check may be selected. The UI screen 310 is switched to a screen for performing setting used in the position check, the posture check, or the model interference check, in accordance with the monitoring method specified in the specified field 311.

The UI screen 310 further includes a selection field 318 for switching between the safety function and the standard function. Whether setting parameters set on the UI screen 310 are used as the safety function or the standard function can be selected by performing an operation on the selection field 318. The function of selection between the safety function and the standard function through the selection field 318 is provided by the switching unit 241. The switching unit 241 switches between the safety function and the standard function in accordance with the selection in the selection field 318. The UI screen 310 in FIG. 8 illustrates a state where the safety function is selected.

When a plurality types of position checks, posture checks, and model interference checks are to be performed, a plurality of UI screens 310 may be prepared. In that case, a UI screen 300 illustrated in FIG. 8 that is a setting screen in an upper layer shows that four parameter sets 301 to 304 are prepared for respective monitoring targets. A part on the right side in FIG. 8 illustrates the UI screen 310 for detailed setting of the parameter set 301. For example, the UI screen 310 may be opened by performing an operation of selecting the parameter set 301 on the UI screen 300. In this case, a user is allowed to select, for each of the parameter sets, whether to use the parameter set as the safety function or as the standard function. In this case, the function of switching between the position check, the posture check, and the model interference check may be implemented in such a way that screens for inputting settings to be used in the position check, the posture check, and the model interference check can be separately opened from the UI screen 300, instead of switching between the position check, the posture check and the model interference check by using the specified field 311 on the UI screen 310.

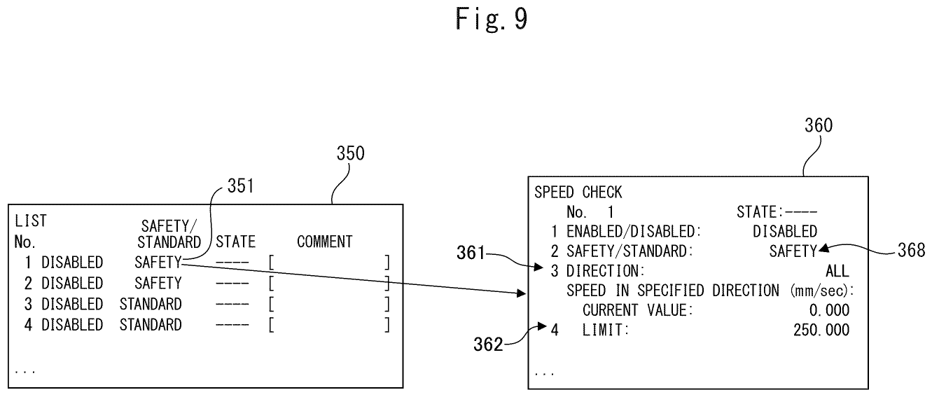

FIG. 9 illustrates an example of a UI screen 360 for performing parameter setting of the speed check. The UI screen 360 includes
a specified field 361 for specifying a direction of the speed check, and
a specified field 362 for specifying a speed limit.
   FIG. 9 illustrates an example where “ALL” for specifying every moving direction is set as the direction in which the speed check is performed in the specified field 361 and “250.000 mm/sec” is set as the speed limit in the specified field 362.

The UI screen 360 further includes a selection field 368 for switching between the safety function and the standard function. Whether setting parameters set in the UI screen 360 are used as the safety function or the standard function can be selected by performing an operation on the selection field 368. The function of selection between the safety function and the standard function through the selection field 368 is provided by the switching unit 241. The switching unit 241 switches between the safety function and the standard function in accordance with the selection in the selection field 368. The UI screen 360 in FIG. 9 illustrates a state where the safety function is selected.

FIG. 9 also illustrates an example of a UI 350 in an upper layer when a plurality of setting parameter sets are created. The aforementioned UI screen 360 is associated with the UI screen 350 in the upper layer as a parameter set 351 being one of a plurality of parameter sets prepared on the UI screen 350.

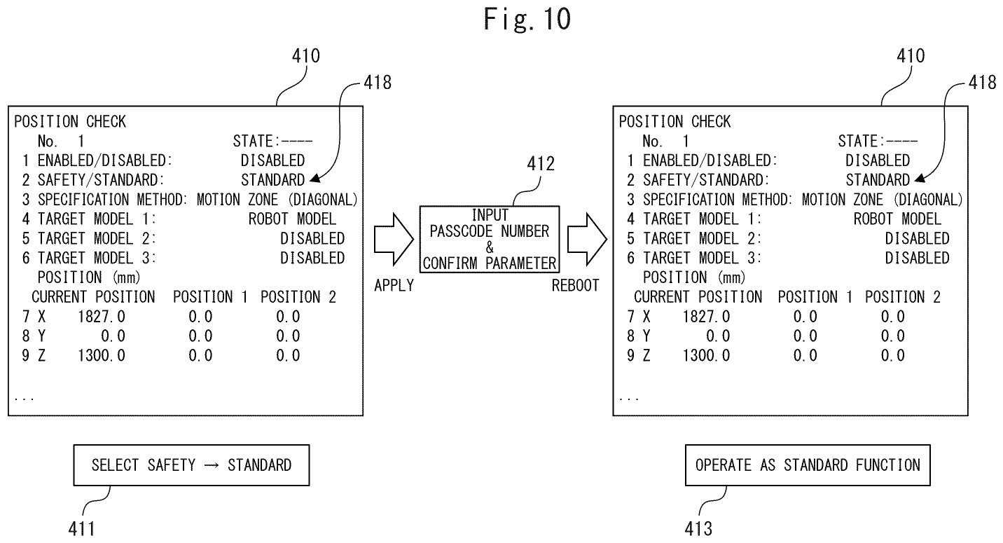

FIG. 10 is a diagram for illustrating a flow of operation when a state of a selection field 418 on a UI screen 410 is switched from the safety function to the standard function. It is assumed as indicated in a box 411 that switching from the safety function to the standard function is selected on the UI screen 410. Since in this case an operation of releasing the safety function, i.e., an operation related to a change in the safety function, is performed, undergoing an applying process of performing passcode number input, parameter content confirmation, and a reboot is requested as an authentication process (a box 412). A user performs input of the passcode number and confirmation of the parameters and inputs an instruction for applying process by an operation through a display screen of the external input device 40 and the operation unit 44. The applying process enables setting parameters on the UI screen 410 to be used as the standard function parameter 221, as illustrated in FIG. 6 (a box 413).

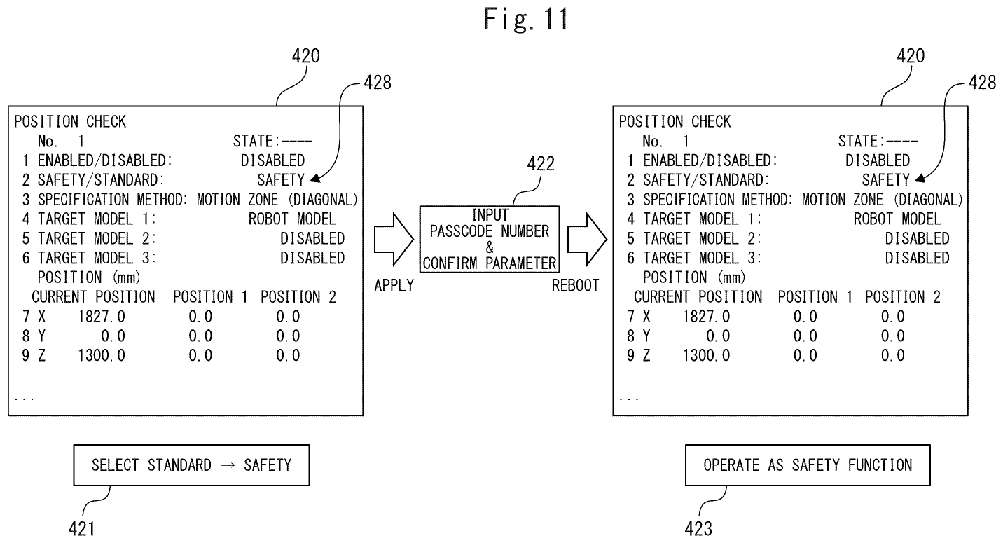

FIG. 11 is a diagram for illustrating a flow of operation when setting in a selection field 428 on a UI screen 420 is switched from the standard function to the safety function. It is assumed as indicated in a box 421 that switching from the standard function to the safety function is selected on the UI screen 420. Since in this case, an operation of newly enabling the safety function is performed, undergoing the applying process of performing passcode number input, parameter content confirmation, and a reboot is requested as an authentication process (a box 422). A user performs input of the passcode number and confirmation of the parameter and inputs an instruction for applying process by an operation through the display screen of the external input device 40 and the operation unit 44. The applying process enables setting parameters on the UI screen 420 to be used as the safety function parameter 211, as illustrated in FIG. 6 (a box 423).

As described above, according to the present embodiment, in terms of the checking function using the setting items common to the safety function and the standard function, switching between execution of the checking function as the safety function and execution of the checking function as the standard function can be easily performed, and thus time required for performing porting of setting information between the safety function and the standard function and re-verification of the setting information can be eliminated and transition between the safety function and the standard function can be performed efficiently.

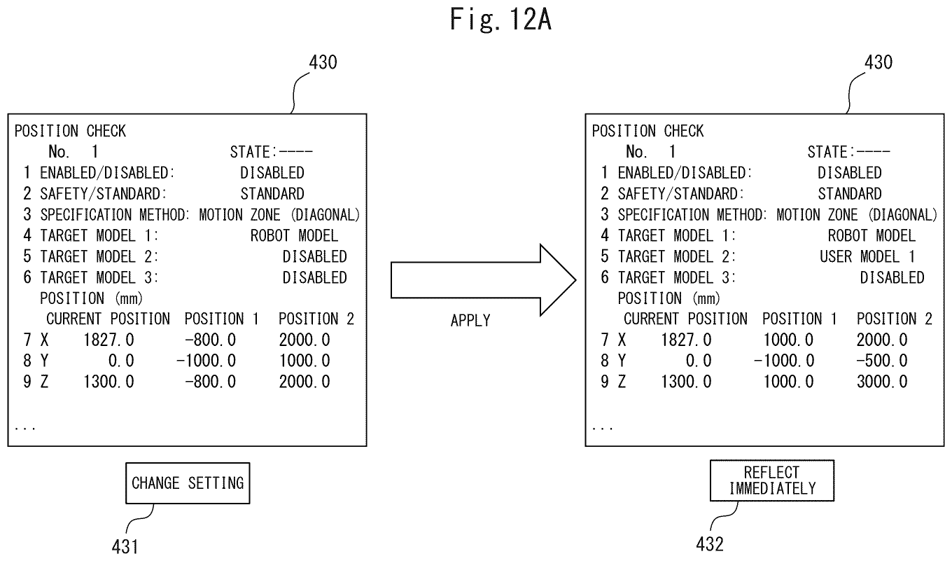

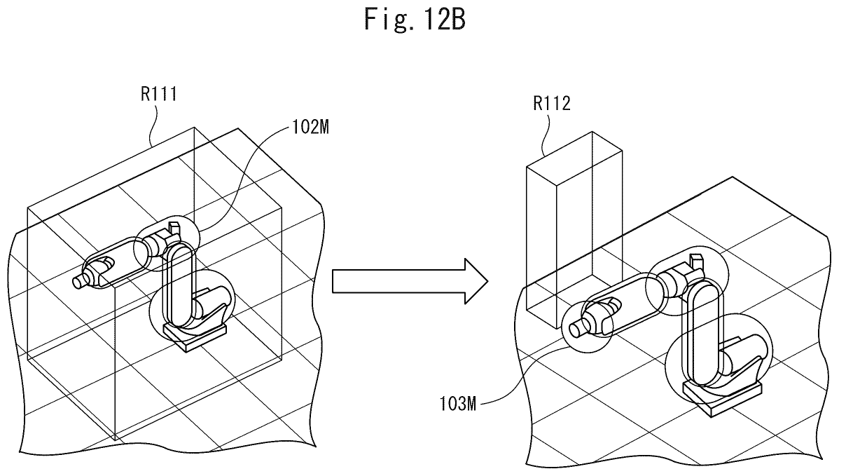

FIG. 12A is a diagram for illustrating a flow of operation of applying changes of setting parameters on a UI screen 430 on which the standard function is selected. When parameters are changed and the changed parameters are applied on the UI screen 430 on which the standard function is selected as indicated in a box 431, the authentication process as is the case in the safety function is not requested. In this case, the setting parameters changed on the UI screen 430 are immediately applied. Alternatively, when a predetermined operation for applying of parameters is performed through the operation unit 44, the parameters may be immediately applied. It is assumed as an example that the position checking function based on parameters before the setting change on the UI screen 430 is set for a position check of a robot model 102M and a motion zone R11l, as illustrated on the left side in FIG. 12B. It is also assumed that the position checking function after the setting change on the UI screen 430 is an interference checking function between a user model 10M and a limiting zone R112, as illustrated in FIG. 12B. In this case, the position checking function immediately switches from the state illustrated on the left side in FIG. 12B to the state illustrated on the right side in FIG. 12B in immediate response to the setting change on the UI screen 430.

As described above, the aforementioned configuration according to the present embodiment enables switching between the safety function and the robot monitoring function based on the standard function in a smooth manner for a user.

While the present invention has been described above by using the typical embodiments thereof, it may be understood by a person skilled in the art that changes, and various other changes, omissions, and additions can be made to the aforementioned embodiments without departing from the scope of the present invention.

The arrangement of the functional blocks in the functional block diagram of the robot controller illustrated in FIG. 7 is an example, and various modified examples related to the arrangement of the functional blocks can be configured. For example, the function as the setting unit 240 may be arranged on the external input device 40 side. In this case, an integrated function into which the function as the external input device 40 and the function as the robot controller 20 are integrated may be defined as the robot controller.

While the position-posture-speed calculation units 251 and 261 are arranged in the standard function unit 250 and the safety function unit 260, respectively, in the functional block diagram illustrated in FIG. 7, a single position-posture-speed calculation unit may be shared by the standard function unit 250 and the safety function unit 260.

The functional blocks in FIG. 7 may be provided by executing, by the processor in the robot controller, various types of software stored in a storage device or may be provided by a configuration mainly based on hardware such as an application specific integrated circuit (ASIC).

A program executing various types of processing in the embodiment described above can be recorded on various computer-readable recording media (such as semiconductor memories such as a ROM, an EEPROM, and a flash memory; a magnetic recording medium; and optical disks such as a CD-ROM and a DVD-ROM).

### REFERENCE SIGNS LIST

10 Robot
11 Sensor unit
20 Robot controller
40 External input device
21, 28 Processor
22 Memory
23 Input-output interface
24 Operation unit
41 Processor
42 Memory
43 Display unit
44 Operation unit
45 Input-output interface
100 Robot system
240 Setting unit
241 Switching unit
242 Zone setting unit
243 Posture limit setting unit
244 Model setting unit
245 Speed limit setting unit
250 Standard function unit
251 Position-posture-speed calculation unit
252 Abnormal position detection unit
253 Abnormal posture detection unit
254 Model interference detection unit
255 Abnormal speed detection unit
260 Safety function unit
261 Position-posture-speed calculation unit
262 Abnormal position detection unit
263 Abnormal posture detection unit
264 Model interference detection unit
265 Abnormal speed detection unit

1. A robot controller for controlling a robot, the robot controller comprising:
a standard function unit configured to control operation of a standard function as the robot and have a function of monitoring the robot;
a safety function unit configured to control a safety function for managing safety in operation of the robot;
a setting unit configured to set setting information related to a setting item used in common in control of the safety function by the safety function unit and monitoring of the robot by the standard function unit; and
a switching unit configured to switch between operation of the safety function performed by the safety function unit based on the setting information and monitoring of the robot performed by the standard function unit based on the setting information.

2. The robot controller according to claim 1, further comprising a stop instruction unit configured to stop the robot when an abnormality is detected in the safety function performed by the safety function unit or an abnormality is detected in monitoring of the robot performed by the standard function unit.

3. The robot controller according to claim 1, wherein
each of the safety function performed by the safety function unit and monitoring of the robot performed by the standard function unit includes at least one item out of
detection of an abnormality in a position of the robot,
detection of an abnormality in a posture of the robot,
detection of interference between the robot and a peripheral device, and
detection of an abnormality in speed of the robot.

4. The robot controller according to claim 1, wherein
the setting item includes at least one of
a setting item related to detection of an abnormality in a position of the robot,
a setting item related to detection of an abnormality in a posture of the robot,
a setting item related to detection of interference between the robot and a peripheral device, and
a setting item related to detection of an abnormality in speed of the robot.

5. The robot controller according to claim 1, wherein the setting unit provides a user interface screen for accepting input of the setting information related to the setting item applied in common to control of the safety function by the safety function unit and monitoring of the robot by the standard function unit.

6. The robot controller according to claim 5, wherein
the user interface screen includes a selection field for selecting one item out of operation of the safety function by the safety function unit and monitoring of the robot by the standard function unit, and
the switching unit switches between operation of the safety function by the safety function unit and monitoring of the robot by the standard function unit in response to a selection operation on the selection field.

7. The robot controller according to claim 1, wherein each of the safety function unit and the standard function unit detects an abnormality in operation of the robot by using a model representing the robot.

8. The robot controller according to claim 1, wherein the safety function unit has a function of performing a diagnosis on whether a function of monitoring the robot as the safety function operates normally.

9. The robot controller according to claim 1, comprising two processors for doubly executing monitoring of the robot based on the safety function performed by the safety function unit.

10. The robot controller according to claim 1, comprising a single processor for executing monitoring of the robot based on the standard function.
